(19) United States
(12) Patent Application Publication
(10) Pub. No.: US 2007/0159456 A1
(43) Pub. Date: Jul. 12, 2007

(54) Navigation system

(76) Inventor: Mark A. Unkrich, Redwood City, CA (US)

Correspondence Address: AVAGO TECHNOLOGIES, LTD., P.O. BOX 1920, DENVER, CO, 80201-1920, US

(21) Appl. No.: 11/328,630

(22) Filed: Jan. 10, 2006

(51) Int. Cl. G09G 5/00

(52) U.S. Cl. 345/156

(57) ABSTRACT

A navigation system including a first navigation sensor configured to provide a first set of positional capacitance values, a second navigation sensor configured to provide a second set of positional capacitance values, and a controller configured to select between the first and second sets of positional capacitance values and to provide navigation information selectively based on the first and second sets of positional capacitance values.

### BACKGROUND

The use of portable electronic devices, such as hand-held computers, personal digital assistants, and cell phones, for example, continues to increase at a rapid pace. Such devices generally employ display screens to convey information to and receive inputs from a user. Because of their typically small size, however, the amount of information able to be displayed to a user at any given time is generally limited.

As such, various navigation devices/techniques have been employed for navigation of the display. One common technique is to employ scrolling keys, usually marked with arrows, to scroll the display in a desired direction. Another approach employs a tilt sensor which controls scrolling of the display in response to changes in the orientation at which the device is held in a user's hand.

Various input devices have been also been developed which enable a user to control a feature of the electronic device via the display such as, for example, moving a cursor, highlighting an object, moving an object, and for selecting and inputting information. Examples of such devices include touchpads, rocker switches, buttons, joysticks, and slide pads. The input devices may also have a mechanism, such as a button, allowing the user to perform functions via the display.

Depending on the requirements of a particular application, certain input devices and display navigation devices may be more suitable for use than others. As such, it may sometimes be advantageous for electronic devices to employ more than one type of input device and/or navigation device. However, since such input and navigation devices are typically separate units, use of multiple input and navigations devices adds cost and requires additional space and computing requirements, both of which are generally at a premium, particularly in hand-held electronic devices.

### SUMMARY

In one embodiment, the present invention provides a navigation system including a first navigation sensor configured to provide a first set of positional capacitance values, a second navigation sensor configured to provide a second set of positional capacitance values, and a controller configured to select between the first and second sets of positional capacitance values and to provide navigation information selectively based on the first and second sets of positional capacitance values.

### BRIEF DESCRIPTION OF THE DRAWINGS

FIG. 1 is a schematic diagram illustrating one embodiment of a navigation system.

FIG. 2 is a perspective view of a host device employing a navigation system.

FIG. 3 is a perspective view of portions of one embodiment of a slide pad.

FIG. 4A is a schematic diagram illustrating one embodiment of a slide pad from a top perspective.

FIG. 4B is a schematic diagram illustrating one embodiment of cross-section of a slide pad.

FIG. 5 is a schematic diagram of one embodiment of an equivalent circuit of a slide pad.

FIG. 6 is a cross-sectional view illustrating portions of one embodiment of a tilt sensor.

FIG. 7 is a schematic diagram of one embodiment of a tilt sensor.

FIG. 8 is a block and schematic diagram illustrating one embodiment of a navigation system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

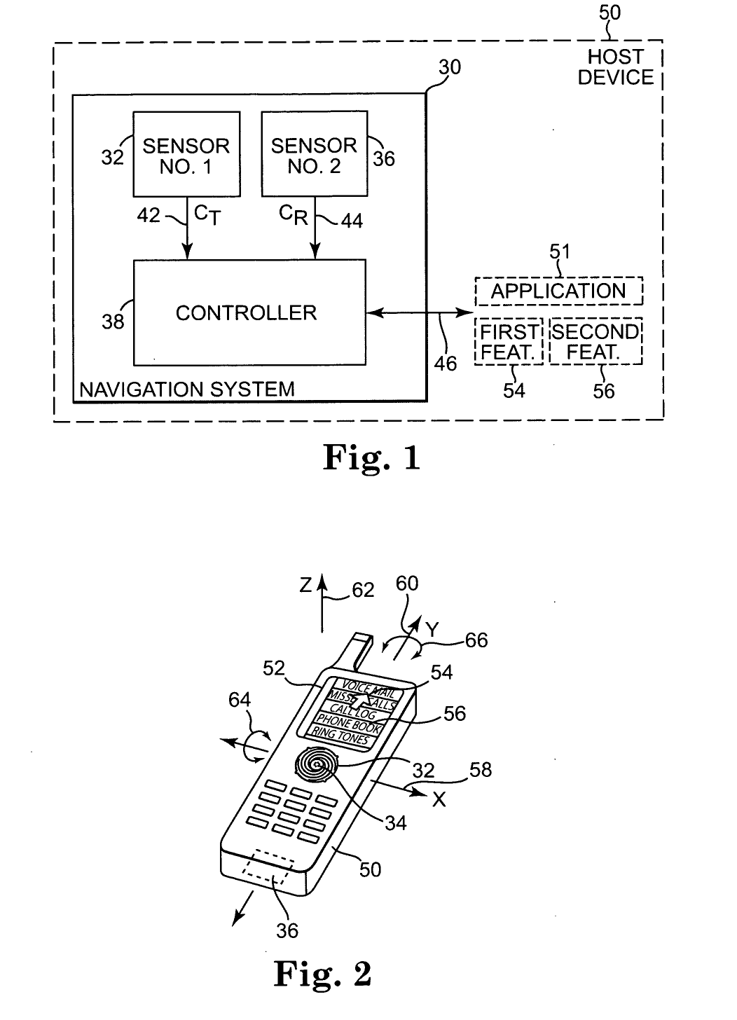

FIG. 1 is a block diagram illustrating generally one embodiment of a navigation system 30 according to the present invention which combines the functionalities of multiple navigation sensors. Navigation system 30 includes a first navigation sensor 32, a second navigation sensor 36, and a control unit 38. First navigation sensor 32 provides a first set of positional capacitance values to controller 38 via a link 42, and second navigation sensor 36 provides a second set of positional capacitance values to controller 38 via a link 44.

Controller 38 is coupled, directly or indirectly, to first and second navigation sensors 32 and 36 and respectively receives the first and second sets of positional capacitance values via links 42 and 44. Controller 38 is configured to select between the first and second sets of positional capacitance values and to generate and provide navigation information via a signal path 46, wherein the navigation information is selectively based on the first and second sets of capacitance values respectively received from first and second navigation sensors 32 and 36.

In one embodiment, controller 38 provides navigation information based only on the first set of positional capacitance values. In one embodiment, controller 38 provides navigation information based only on the second set of positional capacitance values. In one embodiment, controller 38 alternately selects between the first and second sets of positional capacitance values and provides navigation information having a first navigation component based on the first set of positional capacitance values and a second navigation component based on the second set of positional capacitance values.

In one embodiment, as illustrated by FIG. 1, navigation system 30 is coupled, directly or indirectly, and comprises a portion of a host device 50, and is configured to provide the navigation information to host device 50 via signal path 46. In one embodiment, navigation system 30 comprises a portion of host device 50, as indicated by the dashed lines in FIG. 1. In one embodiment, host device 50 comprises a portable electronic device, such as a mobile phone and a portable gaming device, for example.

In one embodiment, host device 50 includes and is configured to execute one or more applications residing therein, such as an application 51, and includes one or more features and/or functions, such as a first feature 54 and a second feature 56. In one embodiment, host device 50 is configured to control first feature 54 and/or second feature 56 based on the navigation information received from navigation system 30 via signal path 46.

In one embodiment, based on requirements of application 51, host device 50 instructs controller 38 via signal path 46 to provide navigation information based on the first set of capacitance values provided by first sensor 32 and/or on the second set of capacitance values provided by second sensor 36. In one embodiment, based on requirements of application 51, host device 50 instructs controller 30 to provide navigation information based only on the first set of capacitance values provided by first navigation sensor 32 and controls first feature 54 or second feature 56 based on said navigation information. In one embodiment, based on requirements of application 51, host device 50 instructs controller 30 to provide navigation information based only on the second set of capacitance values provided by second navigation sensor 32 and controls first feature 54 or second feature 56 based on said navigation information.

In one embodiment, based on requirements of application 51, host device 50 instructs controller 30 to provide navigation information with the first navigation component based on the first set of capacitance values provided by first navigation sensor 32 and the second navigation component based on the second set of capacitance values provided by the second navigation sensor 36. In one embodiment, host device 50 controls first feature 54 based on the first navigation component and the second feature 56 based on the second navigation component.

In one embodiment, navigation system 30 is configured to provide the navigation information comprising the first navigation component based on the first navigation sensor 32 and the second navigation component based on the second navigation sensor 36, and host device 50 is configured to selectively monitor the first and/or second navigation components and control the first and/or second features 54 and 56 based on the requirements of application 51.

FIG. 2 is a block diagram illustrating generally one embodiment of a host device 50 employing one embodiment of a navigation system 30 in accordance with the present invention. In the embodiment of FIG. 2, host device 50 consists of a mobile phone including a visual display 52, where the first feature 54 comprises a pointer or cursor 54 and the second feature 56 comprises a display background 56.

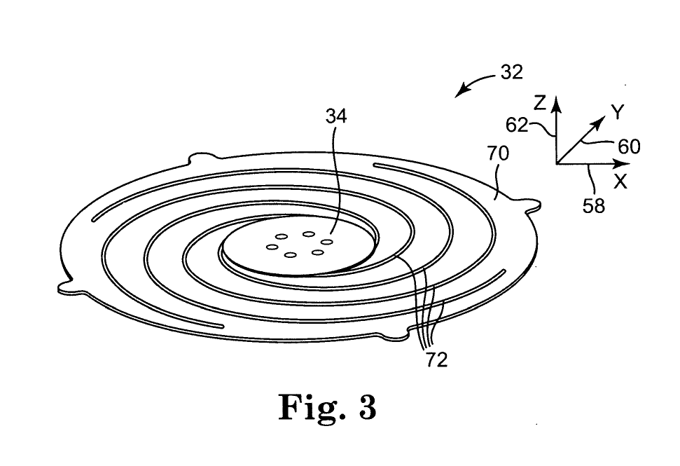

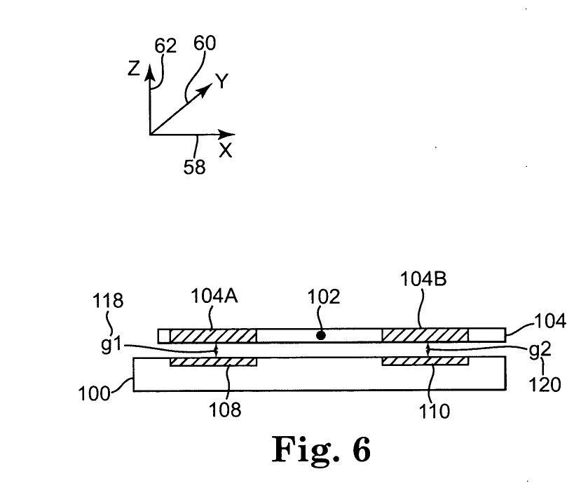

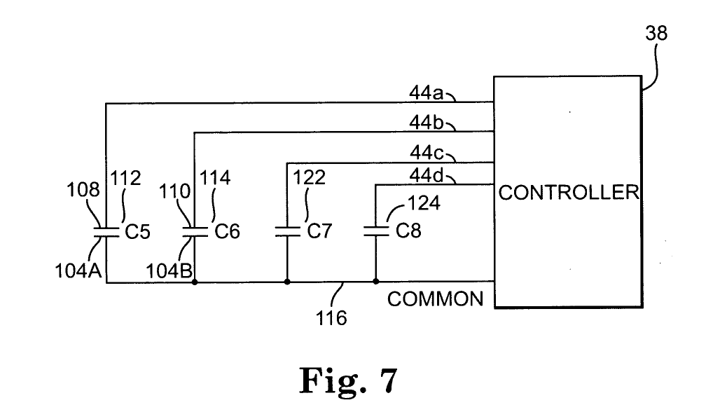

In one embodiment, as illustrated generally in FIG. 2 and as will be described in greater detail below with respect to FIGS. 3-5, first navigation sensor 32 comprises a slide pad configured to provide a first set of capacitance values comprising a set of translational capacitance values (illustrated as “C_{T}” in FIG. 1) which is indicative of translational movement imparted to the slide pad relative to a set of axes, such as x-, y-, and z-axes 58, 60, and 62. In one embodiment, also illustrated generally in FIG. 2 and as will be described in greater detail with respect to FIGS. 6-7, second navigation sensor 36 comprises a tilt sensor configured to provide a second set of capacitance values comprising a set of rotational capacitance values (illustrated as “C_{R}” in FIG. 1) which is indicative of rotational movement of navigation system 30 relative to a set of axes, such as rotational movement 64 relative to x-axis 58 and rotational movement 66 relative to y-axis 60.

Host device 50, such as mobile phone 50 of FIG. 2, employs the navigation information to control one or more features and/or functions associated with host device 50, such as cursor 54 and background 56, based on the requirements of a particular application, being executed, such as application 51. For example, in one embodiment, mobile phone 50 instructs navigation system 30 to provide navigation information based only on the first set of capacitive values provided by first navigation sensor 32 and employs the navigation information to control movement of cursor 54. In one embodiment, mobile phone 50 instructs navigation system 30 to provide navigation information based only on the second set of capacitive values provided by second navigation sensor 36, and employs the navigation information to control movement of background 56 (e.g. up/down scrolling).

In one embodiment, mobile phone 50 instructs navigation system 30 to provide navigation information having first and second navigation components based respectively on the first and second sets of capacitance values provided by first and second navigation sensors 32 and 36, and employs the first navigation component to control a first feature and the second navigation component to concurrently control a second feature. For example, in one embodiment, where first navigation sensor 32 comprises a slide pad and provides a first set of capacitance values comprising translational capacitance values (C_{T}) indicative of translational movement and second navigation sensor 36 comprises a tilt sensor and provides a second set of capacitance values comprising rotational capacitance values (C_{R}) indicative of rotational movement, host device 50 employs the first navigation component to control movement of cursor 54 and the second navigation component to concurrently control movement (e.g. up/down and left/right scrolling) of display background 56.

In one embodiment, when providing navigation information including the first and second navigation components, controller 38 is configured to select between the first and second sets of positional capacitance values and to provide the first and second navigation components at a frequency which is imperceptible to a user. In this fashion, concurrent control of first and second features by a host device, such as cursor 54 and background 56 by mobile phone 50, appears to be simultaneous to a user.

By employing controller 38 to select between and generate navigation information based on the first and second sets of positional capacitance values provided by first and second navigations sensors 32 and 36, navigation system 30 according to the present invention combines the functionality of multiple navigation sensors while reducing processing and power requirements, system cost, and conserving valuable space relative to “stand alone” navigations sensors providing similar functionality. For example, in one embodiment, as described generally above and in more detail below, navigations system 30 combines the functionality of a slide pad and a tilt sensor. However, although first and second navigation sensors 32 and 36 are described herein primarily in terms of a slide pad sensor and a tilt sensor, navigation system 30 is not limited to use with such navigation sensors and may be configured to use with any number of types of navigation sensors employing differential capacitance values which are representative of detect movement (e.g. joy sticks), and may be configured with navigations sensors 32 and 36 each comprising a slide pad.

As described above, by selecting between the first and second sets of positional capacitance values at a user imperceptible rate, navigation system 30 provides what is perceived to a user as simultaneous multi-axis control of two display objects. For example, in a gaming application, navigation system 30 may provide two-axis control to a first screen object via first navigation sensor 32 and two-axis control of a background scene or a second screen object via second navigation sensor 36.

Although described above as providing two-dimensional or two-axis control, both first and second navigations sensors, as will be described in greater detail below, may be configured to provide three-dimensional control. As will be described below, such three-dimensional control may be configured to provide “click state” functionality which may be employed by a host device to select or initiate a function or option associated with the host device.

FIGS. 3-5, with further reference to FIGS. 1 and 2, illustrate one example embodiment of first navigation sensor 32, wherein the first navigation sensor 32 comprises a slide pad. FIG. 3 is a perspective view of one embodiment of slide pad 32 as illustrated by FIG. 2. Slide pad 32 includes a slide disk 34, a frame 70, and a plurality of spring devices 72 connected, directly or indirectly, to slide disk 34 and frame 70. A user varies the values of translational capacitance values 42 by moving slide disk 34 in two directions, hereinafter referred to as the x and y directions as illustrated by x- and y-axes 58 and 60, wherein the translational capacitance values are indicative of a position of slide disk 34 within frame 70.

Spring devices 72 operate to bias slide disk 34 toward a center position within frame 70 in the x and y directions. A user moves slide disk 34 within frame 70 by applying sufficient force, such as via a fingertip, to slide disk 34 in the x and/or y direction to overcome a resistance of spring devices 72. When the resistance of spring devices 72 exceeds the x and/or y direction force applied to slide disk 34 by the user (e.g. when the user releases the x and/or y direction force on slide disk 34), spring devices 72 cause slide disk 34 to return to or toward the center position in the x and y directions.

In one embodiment, the user varies the translational capacitance values (C_{T}) by moving slide disk 34 in a third direction, referred to herein as the z direction, as illustrated by z axis 62 (see FIG. 2). One or more internal spring devices (not shown) operate to bias slide disk 34 toward a center position in the z direction. The internal spring device may comprise a bi-stable dome switch (not shown), for example. The user causes functions of a host device, such as host device 50, to be performed by applying and/or releasing pressure on slide disk 34 in the z direction. For example, the user may apply and release pressure on slide disk 34 any number of times to cause one or mores “clicks” of varying durations to be performed. When the resistance of the internal spring devices exceeds the z direction pressure applied to slide disk 34 by the user (e.g., when the user releases the z direction pressure on slide disk 34), spring devices 72 cause slide disk 34 to return to or toward the center position in the z direction.

As will be described in greater detail below, controller 38 measures the translational capacitance values (C_{T}) to determine an amount of movement of slide disk 34 in the x, y, and z directions. From the measured values of the translational capacitance values, controller 38 generates and provides the first component of navigation signal 46 to host device 50. In one embodiment, host 50 adjusts a position of curser 54 based on the first component of navigation signal 46 corresponding to movement of slide disk 34 in the x and y directions. In one embodiment, from the measurements in the z direction, controller 38 generates and includes a click state as part of the first component of navigation signal 46. In one embodiment, host 50 causes one or more functions to be performed using the click state.

In one embodiment, slide pad 32 and controller 38 of navigation system 30 are configured to operate according to one or more modes of operation. The modes of operation may include a mouse mode, a one-to-one mode, and a joystick mode.

In the mouse mode, controller 38 outputs a first component of navigation signal 46 to cause cursor 54 of host 50 to be moved relative to the movement of slide disk 34 in the x and/or y directions. When the user allows slide disk 34 to return to the center position of the x and y directions, controller 38 outputs a first navigation component of navigation signal 46 to cause cursor 54 of host 50 to remain in place, i.e., not move back to a neutral position in display 52 of host 50.

In the one-to-one mode, controller 38 outputs a first navigation component of navigations signal 46 to cause cursor 54 of host 50 to track the movement of slide disk 34 in the x and/or y directions. When the user allows slide disk 34 to return to the center position of the x and y directions, controller 38 outputs a first navigation component of navigations signal 46 to cause cursor 54 of host 50 to move back to the neutral position in display 52 of host 50. The neutral position in the display corresponds to the center position of the x and y directions of slide pad 32.

In the joystick mode, controller 38 outputs a first navigation component of navigation signal 46 to cause cursor 54 of host 50 to move in a direction and velocity based on the position of slide disk 34 in the x and/or y directions. The further the user moves slide disk 34 from the center position of the x and y directions, the faster the pointer is moved in display 52 of host 50. When the user allows slide disk 34 to return to the center position of the x and y directions (i.e., the zero direction and zero velocity position of slide pad 32), controller 38 outputs a first component of navigation signal 46 to cause cursor 54 of host 50 to remain in place (i.e. not move back to a neutral position in display 52 of host 50).

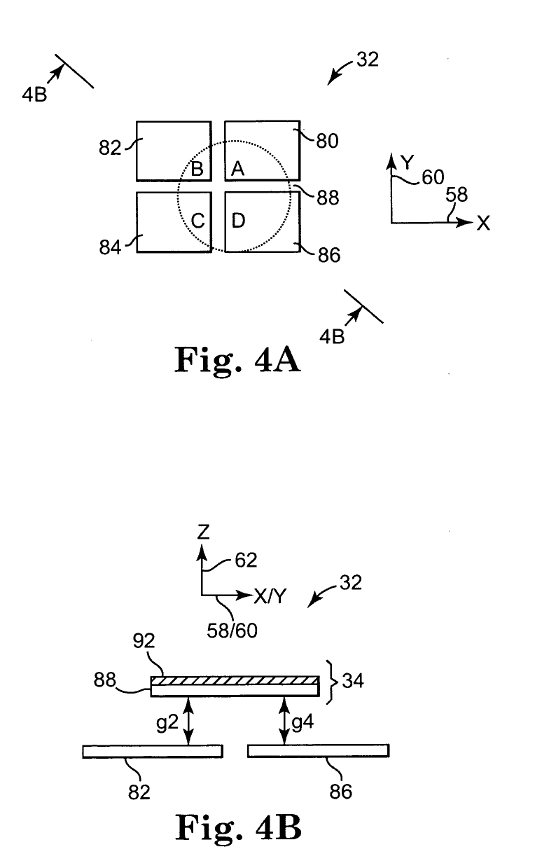

FIG. 4A is a schematic diagram illustrating generally a top perspective of one embodiment of slide pad 32. Slide pad 32 includes position electrodes 80, 82, 84, and 86, and a disk-shaped sensor electrode 88. FIG. 4B is a schematic diagram illustrating generally a cross-section of slide pad 32 of FIG. 4A along a section line labeled as “4B.” Position electrodes 82 and 86 (and electrodes 80 and 84, not shown) are set in a first plane formed in the x and y directions, and sensor electrode 88 is set a second plane formed in the x and y directions but displaced from the first plane in the z direction as respectively indicated by gaps g2 and g4 between position electrodes 82 and 86 and sensor electrode 88. In one embodiment, sensor electrode 88 includes an insulating layer 92 such that sensor electrode 88 and insulating layer 92 together form slide disk 34. In one embodiment (not illustrated), an insulating layer is provided on sensor electrodes 80-86.

Position electrodes 80-86 are electrically isolated from one another and from sensor electrode 88. In one embodiment, as illustrated by FIG. 4B, sensor electrode 88 forms a bottom surface of slide disk 34 and is covered with an insulating material (e.g. a dielectric material) that enables a user to move slide disk 34, including sensor electrode 88, in the x and y directions, as indicated by x- and y-axes 58 and 60. An overlap between sensor electrode 88 and each position electrode 80-86 are respectively illustrated by letters A-D in FIG. 4A. An area of each of the overlaps A-D depends on the lateral (x-y) position of sensor electrode 88 relative to position electrodes 80-86. Each position electrode 80-86 is capacitively coupled with sensor electrode 88 such that an x-y position of sensor electrode 88 can be determined based on the area of each of the overlaps A-D with position electrodes 80-86.

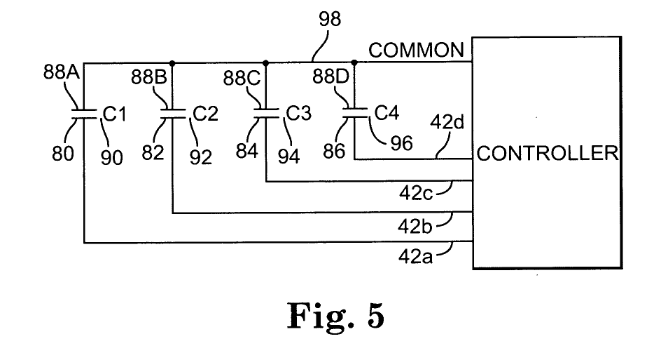

FIG. 5 is a schematic diagram of an equivalent circuit of slide pad 32 illustrated above by FIGS. 4A and 4B. With reference to FIG. 4A, the portions of sensor electrode 88 that overlap position electrodes 80-86 are represented by electrodes 88A through 88D. The portion 88A of sensor electrode 88 that overlaps position electrode 80 forms a parallel plate capacitor 90 having a capacitance value C1 that is proportional to the area of overlap A. Similarly, the portion 88B of sensor electrode 88 that overlaps position electrode 82 forms a parallel plate capacitor 92 having a capacitance value C2, the portion 88C of sensor electrode 88 that overlaps position electrode 84 forms a parallel plate capacitor 94 having a capacitance value C3, and the portion 88D of sensor electrode 88 that overlaps position electrode 86 forms a parallel plate capacitor 96 having a capacitance value C4.

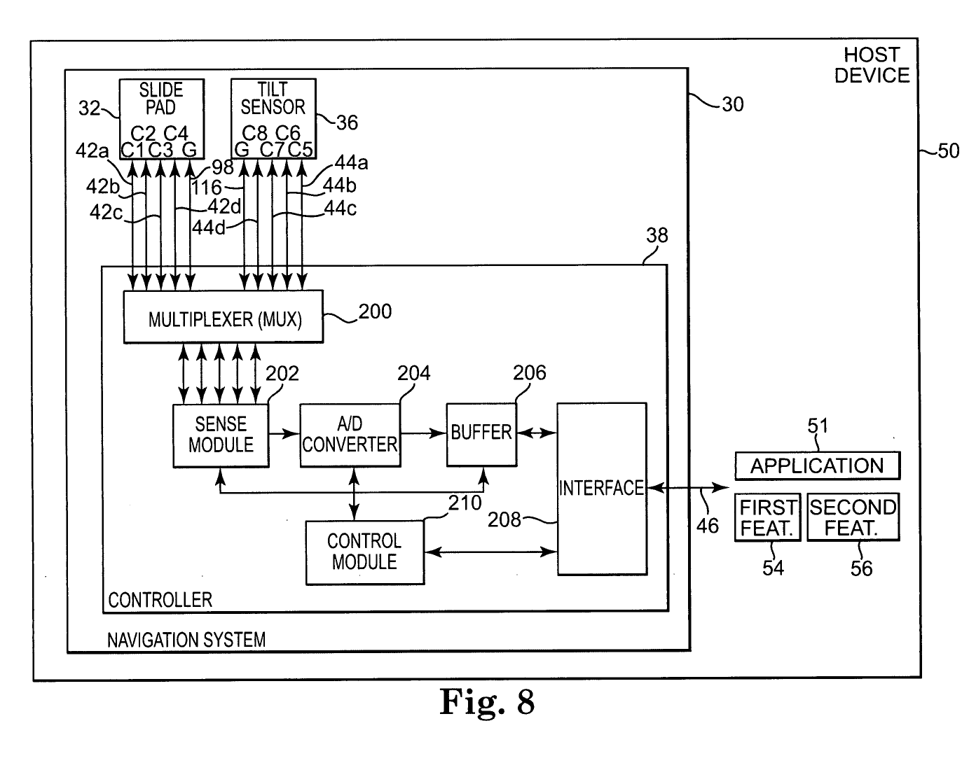

In one embodiment, position electrodes 80-86 are coupled to controller 38 via link 42 (see FIG. 1), illustrated as links 42a, 42b, 42c, and 42d, and sensor electrodes 88A-88D are coupled to controller 38 via a common line 98. As such, capacitance values C1, C2, C3, and C4 of parallel plate capacitors 90-96 form translational capacitance values (C_{T}) provided by first navigation sensor 32 to controller 38 via link 42 (see FIG. 1). As sensor electrode 88 is moved in the x and y directions, the area of overlap A-D of sensor electrode 88 with each position electrode 80-86 changes, resulting in a corresponding change in translational capacitance values C1-C4 of parallel plate capacitors 90-96. When sensor pushed downward in the z direction, the gaps between sensor electrode 88 and position electrodes 80-86 decreases (e.g. gaps g2 and g4 with respect to FIG. 4B) resulting in an increase in the values of capacitance values C1-C4. As will be described in greater detail below with respect to FIG. 8, by measuring capacitance values C1-C4 of parallel plate capacitors 90-96, controller 38 can determine the x, y, and z position of sensor electrode 88 relative to position electrodes 80-86.

FIG. 6 is a cross-section view illustrating generally portions of one example implementation of a micro-electromechanical (MEMs) type accelerometer which is suitable to be configured for use as tilt sensor 36 of navigation system 30 according to the present invention. It is noted that tilt sensor 36 may comprise any number of configurations and implementations and that the example implementation of FIG. 6 is included for illustrative purposes and is representative of one such implementation.

Tilt sensor 36 includes a substrate 100 and a sensor electrode 104 which is suspended above substrate 100 and configured to rotate about an axis 102. As illustrated in FIG. 6, electrode plate 104 is configured to rotate about y-axis 60. Tilt sensor 36 includes a position electrode 108 and a position electrode 110 formed in substrate 100. Sensor electrode 104 has an overlap area 104A with position electrode 108 and an overlap area 104B with position electrode 110. Together, with reference to FIG. 7 below, overlap areas 104A and 104B and position electrodes 108 and 110 form the electrodes of a pair of variable air gap capacitors 112 and 114, with an average gap distance g1 118 between overlap area 104A and sensor electrode 108 and an average gap distance g2 120 between overlap area 104B and sensor electrode 110.

With reference to FIG. 6, sensor electrode 104 is asymmetric in nature, such that one side is heavier than the other, resulting in a center of mass that is offset from axis 102. As illustrated, the side of sensor electrode 104 corresponding to overlap area 104B is heavier than the side corresponding to overlap area 104A. When an acceleration force produces a moment about axis 102, which corresponds to y-axis 60 in the illustrated example of FIG. 6, sensor electrode 104 rotates about axis 102 causing the average gap distance between the electrodes of one of the capacitors 112 and 114 to decrease (thereby increasing its capacitance) and the average gap distance between the electrodes of the other capacitor to increase (thereby decreasing its capacitance). For example, in response to a clockwise rotation of sensor electrode 104 about axis 102, average gap distance g2 120 decreases and average gap distance g1 118 increases, resulting in an increase in capacitance of capacitor 114 formed overlap area 104B and sensor electrode 110 and a decrease in capacitance of capacitor 112 formed by overlap area 104A and electrode 108.

As illustrated by FIG. 6, tilt sensor 36 is configured to detect rotation about a single axis 102, which corresponds to y-axis 60 in the illustrated example. However, although not illustrated, tilt sensor 36 may be configured with structure and components similar to that of FIG. 6 to enable detection of movement about additional axes as well. For example, in one embodiment (see FIG. 7 below) tilt sensor 36 includes structure similar to that illustrated by FIG. 6 and having a pair of variable air gap capacitors to detect rotational motion about x-axis 58. Additionally, although illustrated by FIG. 6 as comprising an accelerometer-type tilt sensor, tilt sensor 36 may comprise other types of tilt sensors, such as an inclinometer, for example.

FIG. 7 is a schematic diagram of an equivalent circuit of tilt sensor 36 as illustrated by FIG. 6 and including additional capacitive elements associated with detecting rotation about x-axis 58. Tilt sensor 36 includes variable capacitors 112 and 114 (as described above with respect to FIG. 6) having capacitance values C5 and C6. As described above, the overlap area 104A of sensor electrode 104 and position electrode 108 form capacitor 112, and the overlap area 104B of sensor electrode 104 and position electrode 110 form capacitor 114. As described above, capacitance values C5 and C6 of capacitors 112 and 114 are indicative of rotation about y-axis 60.

Tilt sensor 36 further includes variable capacitors 122 and 124 having capacitance values C7 and C8. Although not illustrated, capacitors 122 and 124 are part of an accelerometer structure, similar to that described by FIG. 6, with capacitance values C7 and C8 of capacitors 122 and 124 being indicative of rotation about x-axis 58.

In one embodiment, the terminals of capacitors 112, 114, 122, and 124 formed by the position electrodes of the corresponding accelerometer structures, such as position electrodes 108 and 110 of capacitors 112 and 114, are coupled to controller 38 via link 44 (see FIG. 1), illustrated as links 44a, 44b, 44c, and 44d, and the terminals of capacitors 112, 114, 122, and 124 formed by the overlap areas of the sensor electrodes, such as overlap areas 104A and 104B of capacitors 112 and 114, are coupled to controller 38 via common line 116. As such, capacitance values C5, C6, C7, and C8 of parallel plate capacitors 112, 114, 122, and 124 form rotational capacitance values (C_{R}) provided by tilt sensor 36 to controller 38 via link 44 (see FIG. 1). As will be described in greater detail below with respect to FIG. 8, by measuring capacitance values C5-C8 of parallel plate capacitors 112, 114 122, and 124, controller 38 can determine the rotational acceleration of tilt sensor 36 about x- and y-axes 58 and 60.

FIG. 8 is a block and schematic diagram illustrating host device 50 including one embodiment of navigation system 30 according to the present invention. Navigation system 30 includes slide pad 32, tilt sensor 36, and controller 38, with controller 38 further including a multiplexer 200, a sense module 202, an analog-to-digital converter (ADC) 204, a buffer 206, an interface 208, and a control module 210. In one embodiment, as illustrated, slide pad 32 comprises a slide pad as illustrated above by FIGS. 3-5 and tilt sensor 34 comprises a tilt sensor as illustrated above by FIGS. 6-7.

Multiplexer (MUX) 200 receives translational capacitance values C1-C4 from slide pad 32 via links 42a-42d and common line 98, and receives rotational capacitance values C5-C8 via links 44a-44d and common line 116. Sense module 202 selects between translational capacitance values C1-C4 and rotational capacitance values C5-C8 received via MUX 200 in response to control signals from control module 210.

In response to selecting translational capacitance values C1-C4 from slide pad 32, sense module 202 provides analog position information and click state information of slide disk 34 (i.e. movement of slide disk 34 relative to x-, y-, and z-axes 58, 60, and 62) to ADC 204 by measuring capacitance values C1-C4 of capacitors 90-96 (see FIGS. 4A, 4B, and 5). In one embodiment, to measure capacitance values C1-C4, sense module 202 sequentially drives capacitors 90-96 to a voltage potential via links 42a-42d.

ADC 204 converts the analog position and click state information to digital form and stores the digital position and click state information in buffer 206. Control module 210 processes the digital position and click state information from buffer 206 and generates and provides navigation information indicative of translational movement of slide disk 34 relative to x- and y-axes 58 and 60 and a click state of slide pad 32 to host 50 via interface 208 and line 46.

In one embodiment, control module 210 determines a position of slide pad 34 relative to x-axis 58 based on subtracting a sum of capacitance values C2 and C3 of capacitors 82 and 84 from a sum of capacitance values C1 and C4 of capacitors 80 and 86. Similarly, in one embodiment, control module 210 determines a position of slide pad 34 relative to y-axis 60 based on subtracting a sum of capacitance values C3 and C4 of capacitors 84 and 86 from a sum of capacitance values C1 and C2 of capacitors 80 and 82. In one embodiment, control module 210 determines a click state of slide pad 32 based on changes in value of a sum of capacitance values C1-C4.

In response to selecting rotational capacitance values C5-C8 from tilt sensor 36, sense module 202 provides analog rotation information of tilt sensor 36 to ADC 204 by measuring capacitance values C5-C6 of capacitors 108 and 110 and capacitance values C7-C8 of capacitors 122 and 124. In one embodiment, to measure capacitance values C5-C8, sense module sequentially drives capacitors 108-110 and 122-124 to a voltage potential via links 44a-44d.

ADC 204 converts the analog rotation information to digital form and stores the digital rotation information in buffer 206. Control module 210 processes the digital rotation information from buffer 206 to generate and provide a navigation signal indicative of rotational movement of navigation system 30 about x- and y-axes 58 and 60 to host 50 via interface 208 and line 46. In one embodiment, control module 210 determines rotation of navigation system 30 about y-axis 60 by determining a difference between capacitance values C5 and C6 of capacitors 112 and 114. Similarly, in one embodiment, control module 210 determines rotation of navigation system 30 about x-axis 58 by determining a difference between capacitance values C7 and C8 of capacitors 122 and 124.

In one embodiment, with reference to FIG. 2, host device 50 comprises a mobile phone with first feature 54 comprising cursor 54 and second feature 56 comprising background 56 of visual display 52. In one embodiment, host device 50 employs the navigation information received from control module 210 via line 46 to control movement of cursor 54, scrolling of background 56, and highlighting, moving, and selecting an object on visual display 52. In one embodiment, a user of host device 50 may choose to control a feature of host device 50 based on navigation information generated by control module 210 from either slide pad 32 or from tilt sensor 36 depending on what seems “natural” to a given user. For example, a first user may choose to scroll through background 56 of display 52 using two-dimensional navigation information derived from slide pad 32, while a second user may choose to scroll through background 56 using two-dimensional navigation information derived from tilt sensor 36.

In one embodiment, host device 50 causes sense module to select between translational capacitance values C1-C4 from slide pad 32 and rotational capacitance values C5-C8 from tilt sensor 36 in an alternating fashion such that the navigation information provided by control module 210 to host 50 via line 46 includes a first navigation component derived from translational capacitance values C1-C4 and a second navigation component derived from rotational capacitance values C5-C8. In one embodiment, host device 50 employs the first and second navigation components to “simultaneously” control two separate features of host device 50.

For example, host device 50 may employ the first navigation component derived from slide pad 32 to control movement of cursor 54 and the second navigation component derived from tilt sensor 36 to “simultaneously” control left/right and up/down scrolling of background 56. In another example, where host device 50 is a gaming device for instance, host device 50 may employ the first navigation component derived from slide pad 32 to control a screen object and the second navigation component to control movement of a screen background or another screen object.

In the above examples, navigation system 30 provides four-axis control to host device 50. In the above examples, host device 50 may additionally employ the click state information of slide pad 32 from the first navigation component to initiate a function of host device 50, such as selecting an option from a menu, for example. In such an instance, navigation system provides five-axis control to host device 50.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A navigation system, comprising:
a first navigation sensor configured to provide a first set of positional capacitance values;
a second navigation sensor configured to provide a second set of positional capacitance values; and
a controller configured to select between the first and second sets of positional capacitance values and to provide navigation information selectively based on the first and second sets of positional capacitance values.

2. The navigation system of claim 1, wherein the navigation information is based only on the first set of positional capacitance values.

3. The navigation system of claim 1, wherein the navigation information is based only on the second set of positional capacitance values.

4. The navigation system of claim 1, wherein the controller selects between the first and second sets of positional capacitance values in an alternating fashion and provides the navigation information including a first navigation component based on the first set of positional capacitance values and a second navigation component based on the second set of positional capacitance values.

5. The navigation system of claim 1, wherein the controller selects between the first and second set of positional values at a frequency such that control of first and second objects of a host device based on the first and second navigation components is substantially simultaneous to a user of the host device.

6. The navigation system of claim 1, wherein one of the first and second sensors comprises a slide pad.

7. The navigation system of claim 1, wherein one of the first and second sensors comprises a tilt sensor.

8. The navigation system of claim 1, wherein one of the first and second sets of positional capacitance values is indicative of translational movement relative to a first set of axes.

9. The navigation system of claim 8, wherein the translational movement comprises two-axis movement.

10. The navigation system of claim 8, wherein the translation movement comprises three-dimensional movement.

11. The navigation system of claim 1, wherein one of the first and second sets of positional capacitance values is indicative of rotational movement relative to a set of axes.

12. The navigation system of claim 11, wherein the rotational movement comprises two axis rotation.

13. The navigation system of claim 11, wherein the rotational movement comprises three-axis rotation.

14. An electronic device, comprising:
a first navigation sensor configured to provide a first set of positional capacitance values;
a second navigation sensor configured to provide a second set of positional capacitance values;
a controller configured to select between the first and second sets of positional capacitance values and to provide navigation information selectively based on the first and second sets of positional capacitance values; and
a display having at least one display feature, wherein control of the at least one display feature is based on the navigation information.

15. The electronic device of claim 14, wherein the controller is configured to select between the first and second sets of positional capacitance values in an alternating fashion and configured to provide the navigation information having a first navigation component based on the first set of positional capacitance values and a second navigation component based on the second set or positional capacitance values.

16. The electronic device of claim 15, wherein the display includes a first and a second display feature, and wherein the controllers is configured to select between the first set of positional capacitance values and the second set of positional capacitance values and is configured to provide the first and second navigation components at a frequency that is imperceptible to human vision such that movement of the first and second display features is substantially simultaneous.

17. The electronic device of claim 14, wherein the first navigation sensor comprises a slide pad such that the first set of positional capacitance values comprises a set of translational capacitance values indicative of translational movement of the electronic device, and where the second navigation sensor comprises a tilt sensor such that the second set of positional capacitance values comprises a set of rotational capacitance value indicative of rotational movement of the electronic device.

18. The electronic device of claim 17, wherein the tilt sensor comprises a micro-electromechanical type accelerometer.

19. The electronic device of claim 17, wherein the set of translational capacitance values are indicative of translational movement relative to at least a pair of perpendicular axes.

20. The electronic device of claim 17, wherein the set of rotational capacitance values are indicative of rotational movement about at least a pair of perpendicular axes.

21. A method of providing navigation information, the method comprising
providing a first set of positional capacitance values with a first navigation sensor;
providing a second set of positional capacitance values with a second navigation sensor; and
generating navigation information selectively based on the first and second sets of positional capacitance values.

22. The method of claim 21, wherein generating the navigation information includes:
generating a first navigation component based on the first set of positional capacitance values; and
generating a second navigation component based on the second set of positional capacitance values.

23. The method of claim 21, wherein one of the first and second navigation sensors comprises a slide pad providing a set of capacitive values indicative of translational movement relative to a set of axes.

24. The method of claim 21, wherein one of the first and second navigation sensors comprises a tilt sensor providing a set of capacitive values indicative of rotational movement relative to a set of axes.
